(19) United States
(12) Patent Application Publication
(10) Pub. No.: US 2014/0313117 A1
(43) Pub. Date: Oct. 23, 2014

(54) CAMOUFLAGED CONNECTED HOME CONTROLLER

(71) Applicant: HONEYWELL INTERNATIONAL INC., Morristown, NJ (US)

(72) Inventors: Kenneth L. Addy, Massapequa, NY (US); Eric Oh, Syosset, NY (US); Tomas Brodsky, Cortlandt Manor, NY (US)

(73) Assignee: Honeywell International Inc., Morristown, NJ (US)

(21) Appl. No.: 13/864,560

(22) Filed: Apr. 17, 2013

(51) Int. Cl. G06F 3/00

(52) U.S. Cl. CPC G06F 3/005
USPC 345/156

(57) ABSTRACT

A home control system comprises a control apparatus for controlling devices in a home. A user interface is mountable to a wall in the home and is operatively connected to the control apparatus. The user interface comprises a display screen for displaying images relating to operation of the controlled devices. A memory stores an image of the wall proximate the user interface device. A control apparatus and the user interface selectively display the image of the wall on the display screen to camouflage the user interface.

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD

This application relates generally to home control systems and, more particularly, to a method and apparatus for providing a camouflaged user interface.

### BACKGROUND

Security systems, such as for homes and businesses, have become commonplace as people seek to protect themselves and their property. Home security systems typically employ sensors at entry points, such as windows and doors, along with interior sensors such as motion detectors and glass break detectors. A control panel allows the user to arm and disarm the system, such as by entering a password on a keypad.

Homes are also filled with other control devices, such as thermostats, intercom systems, home entertainment controllers, etc. These devices also include control panels.

The control panels function as a user interface for the particular control system. The control panels are designed to blend into the home decor but are usually visible and unattractive.

Accordingly, there is a need for a convenient way to provide a control panel which better blends into its surroundings.

Other features and advantages will be apparent from a review of the entire specification, including the appended claims and drawings.

### SUMMARY

As described herein, a home control system includes a camouflaged user interface.

Broadly, there is disclosed herein a home control system comprising a control apparatus for controlling devices in a home. A user interface is mountable to a wall in the home and is operatively connected to the control apparatus. The user interface comprises a display screen for displaying images relating to operation of the controlled devices. A memory stores an image of the wall proximate the user interface device. A control apparatus and the user interface selectively display the image of the wall on the display screen to camouflage the user interface.

The user interface may be a peripheral device to the control apparatus and the memory may be in the peripheral device. Alternatively, the memory may be in the control apparatus.

The user interface may communicate with the control apparatus using a wireless interface.

The user interface may comprise a touch screen for entering commands to operate the control apparatus and may be operable to adjust size and orientation of the displayed image to match the wall.

The control system may comprise a camera operatively connected to the control apparatus for generating the image of the wall stored in the memory.

The control apparatus may comprise an input device connectable to an external device for transferring the image to the memory.

The control apparatus may also operate using a screen saver mode to selectively display the image of the wall on the display screen to camouflage the user interface.

There is also disclosed herein a security system with a camouflage connected controller comprising a programmed control apparatus for controlling a security system that secures a home. The user interface is mountable to a wall in the home and is operatively connected to the control apparatus. The user interface comprises a touch screen for receiving user input commands for operating the security system and displaying images relating to operation of the security system. A memory stores an image of the wall proximate the user interface. The control apparatus is programmed to selectively display the image of the wall on the touch screen to camouflage the user interface.

Other features and advantages will be readily apparent from a review of the entire specification, including the appended claims and drawings.

### BRIEF DESCRIPTION OF THE DRAWINGS

FIG. 1 is a block diagram of an exemplary home control system, such as a security system;

FIG. 2 is a flow diagram illustrating operation of the security system of

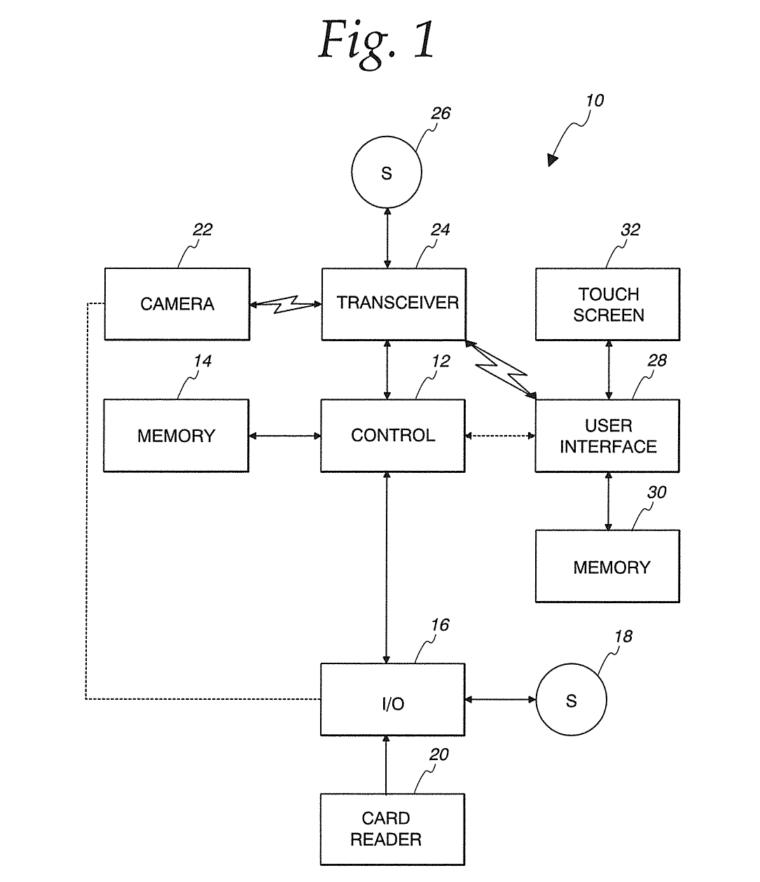

FIG. 1; and

FIG. 3 is a flow diagram illustrating operation of a program implemented by the control system of FIG. 1.

### DETAILED DESCRIPTION

FIG. 1 illustrates an overview of an exemplary home control system in the form of a security system. Many buildings such as homes and small businesses today are equipped with security systems to secure the buildings, e.g., by deterring burglaries and detecting fires or noxious fumes such as carbon monoxide. A typical security system includes a central control panel that communicates with a number of sensors via a wired or wireless path. For example, the control panel may receive signals from motion sensors that detect when a person enters a room. Signals received from fire sensors indicate that a fire has been detected. Signals received from window and door sensors indicate that a window or door has been opened.

Signals received from a peripheral user interface device, such as a keypad and display, a combined display and touch screen, and/or a voice interface, may arm and disarm the system. The user interface device may be the primary interface between the human user and the security system when the user is in the home. The user interface device typically includes components that are analogous to the control panel, including a control, memory and power source. Optionally, the user interface device includes a transceiver (transmitter and receiver). The user interface device is commonly provided as a wireless device to allow it to be permanently installed in the home without running wire, such as by affixing it to a wall or placing it on a table, for instance. Moreover, multiple user interface devices may be provided in a home, such as in different rooms. The control panel generally is a larger component that may be installed in an unobtrusive location in the home, such as a closet or basement. However, it is not necessary for the user interface device to be separate from the control panel, or to communicate by wireless signals with the control panel. For example, the user interface device may be integrated into the control panel.

Various other components may communicate with the control panel. The control panel may also transmit signals to components of the security system. For example, signals may be transmitted to a siren to activate the siren when an alarm condition is detected. Signals may be sent to the user interface device to display status information to the user, such as whether the system is armed or disarmed, whether a specific door or window has been opened, and, when the system is armed, whether an alarm has been tripped. The control panel may also have the ability to notify local emergency services and/or a remote monitoring station of an alarm condition via a telephone dialer. Other communication paths such as long-range radio may also be used. The dialer is typically hardwired to the control panel and activated by the control.

As described herein, the user interface is provided via a user control panel designed to reduce the visual impact of home control systems. The security system may include a camera for remote viewing. This camera would be used to image the background upon which the control panel is mounted. The image of the background is used as a screen saver to camouflage the control panel in its mounted location. This feature could be used even for a system without a camera by using a smart phone camera or a stand alone camera to send the wall image to the device. The system stores the image of the mounting location, transfers it to the control panel and uses it as a screen saver to camouflage the device in its mounted location.

Referring to FIG. 1, a security system 10 is illustrated in block diagram form. The security system 10 includes a control 12. The control 12 includes a microprocessor that may execute software, firmware, or the like, to implement logic to control the security system 10. The control 12 is operatively connected to a memory 14. The memory 14 may include volatile memory and/or non-volatile memory, as necessary, for storing software for operating the control 12 and data. The control 12 is connected to an input/output (I/O) interface 16. The I/O interface 16 selectively connects to a plurality of wired sensors, one of which 18 is illustrated. The sensor 18 could be a door sensor, window sensor, motion sensor, or the like, as necessary for the particular security application. The I/O interface 16 is also connected to a card reader 20 for reading image files and the like from an external memory card or may also include a USB port or the like for connection to a camera 22 for transferring images to the control 12. Alternatively, the camera 22 may communicate wirelessly via a transceiver 24 connected to the control 12. The transceiver 24 may communicate using WiFi, or the like, for transferring images. Likewise, the transceiver 24 may be in operative communication with wireless sensors 26 for use as part of the security system 10.

The control 12 is operatively connected to a control panel 28 functioning as a user interface. The control 12 and user interface 28 may be connected by a wireless connection or a wired connection, as necessary or desired. The user interface 28 includes an associated memory 30. The user interface 28 may include its own microprocessor for implementing control functions or may simply be an I/O device relatively to the control 12. In an illustrative embodiment, the user interface 28 includes a conventional touch screen 32 for receiving user input commands for operating the security system 10 and displaying images relating to operation of the security system 10.

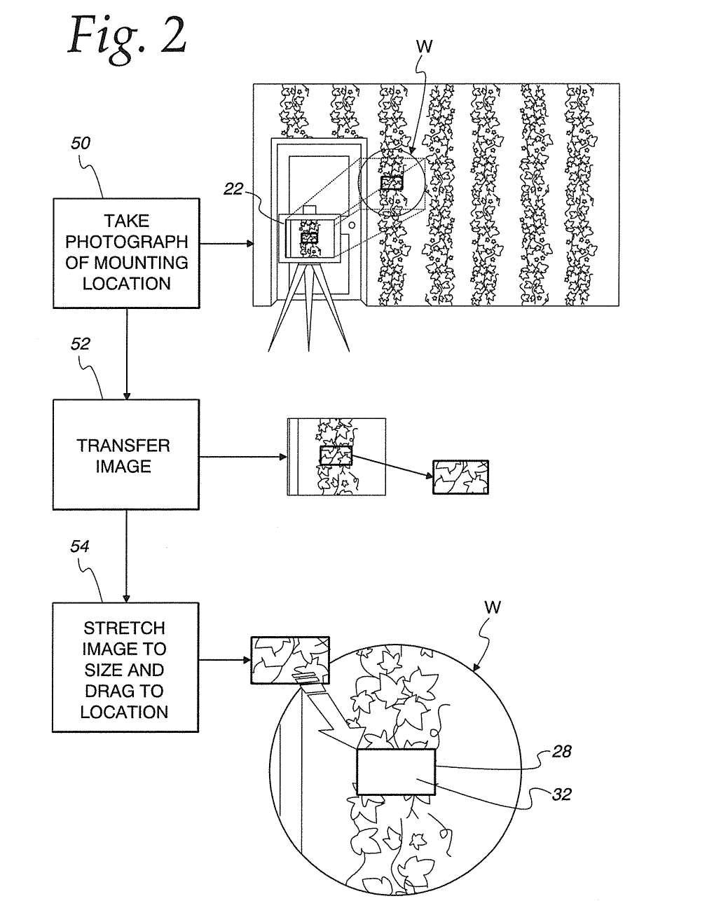

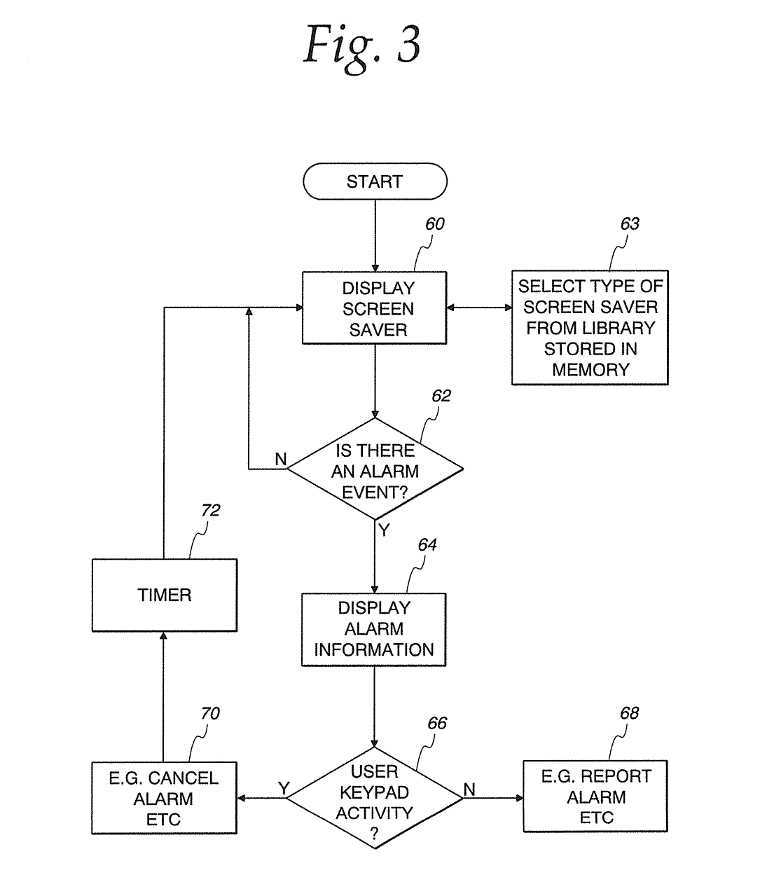

Referring also to FIG. 2, the user interface 28 is illustrated mounted at a select location on a wall W. As is apparent, the wall includes some decorative aspect which may be simply paint color or paint design or wallpaper, or the like, providing a unique appearance. In order to camouflage the user interface 28, the touch screen 32 is operated as a screen saver to display an image that blends in with the surrounding wall W. This is illustrated by a user having a camera 22 recording an image of the wall W user interface 28 and taking a photograph of the mounting location as indicated at 50. The image is then transferred to the control 12 as indicated at 52. This could be done directly if the camera 22 is an integral component of the security system 10 or by transferring the image via wireless connection or wired connection to be stored in the memory 14 and/or the memory 30, see FIG. 1. The image is then displayed on the touch screen 32. The user may drag and stretch the image as indicated at block 54 to better align the image relative to the surrounding wall. Also, the image could be rotated. The resulting image as modified is stored in the memory 14 and/or the memory 30.

FIG. 3 illustrates a flow diagram of a screen saver routine implemented in the control 12 and/or the user interface 28. The routine begins at a block 60 for displaying the screen saver image. Using a programming mode, the user can implement a block 63 which allows the user to select the type of screen saver image from a library stored in memory. The user can also adjust the image such as by dragging or stretching the image, as discussed above, or using a color pallet to modify the color of the image to better blend in with the surrounding wall W. Also, if the background is a plain wall, then the color palette could be used to match the shade of the wall. The color choices could be provided in a pull-down menu to offer a variety of shades to fill the screen saver and the home screen background.

Under normal operation, the program periodically advances to a decision block 62 which determines if there is an alarm event or if the user has touched the touch screen 32 to access the home screen. If not, then the program returns to the block 60 to display the screen saver image. If there is an alarm event, then the alarm information is displayed on the touch screen 32 at a block 64. Likewise, if the user touches the touch screen 32 then the home screen is displayed. The alarm information may include, for example, the sensor 18 or 26 that sensed an alarm condition. A decision block 66 determines if there has been any keypad activity using the touch screen 32. If not, then the alarm is reported at a block 68 to the alarm company monitoring the account, as necessary. If there is keypad activity such as the user disarming the system, then alarm is cancelled at a block 70 and the security system 10 returns to its normal operation. Thereafter, the system waits at a timer block 72 prior to returning to the screen saver mode. At the end of this delay time, the program advances to the block 60 to display the screen saver image.

In applications other than home security systems, the block diagram of FIG. 1 would operate similarly, except for possibly eliminating the sensors. For example, the control panel could be used as part of an HVAC control system, a home intercom system, home entertainment system, or the like, using a user interface 28 with a similar image display.

Additionally, one of the sensors could be an ambient light sensor which is used by the control 12 to automatically adjust the brightness of the image based on ambient light to make it darker in the evening and brighter during the day.

The control panel 28 includes a transceiver for transmitting and receiving wireless signals. The control 12 includes a microprocessor that may execute software, firmware, micro-code or the like to implement logic to control the security system 10. The control panel 28 may include a non-volatile memory and other additional memory as required. The various memories are used for storing software or other instructions that are executed by the control 12 to achieve the functionality described herein and may be considered a programmed storage device. A dedicated chip such as an ASIC may also be used.

It will be appreciated by those skilled in the art that there are many possible modifications to be made to the specific forms of the features and components of the disclosed embodiments while keeping within the spirit of the concepts disclosed herein. Accordingly, no limitations to the specific forms of the embodiments disclosed herein should be read into the claims unless expressly recited in the claims. Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

The present system and method have been described with respect to flowcharts and block diagrams. It will be understood that each block of the flowchart and block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions. None of the methods according to various aspects disclosed herein is limited to performing the steps thereof in any particular order.

1. A home control system, comprising:
a control apparatus for controlling devices in a home;
a user interface mountable to a wall in the home and operatively connected to the control apparatus, the user interface comprising a display screen for displaying images relating to operation of the controlled devices; and
a memory storing an image of the wall proximate the user interface,
the control apparatus and the user interface selectively displaying the image of the wall on the display screen to camouflage the user interface.

2. The home control system of claim 1 wherein the user interface is a peripheral device to the control apparatus and the memory is in the peripheral device.

3. The home control system of claim 1 wherein the memory is in the control apparatus.

4. The home control system of claim 1 wherein the user interface communicates with the control apparatus using a wireless interface.

5. The home control system of claim 1 wherein the user interface comprises a touch screen for entering commands to operate the control apparatus.

6. The home control system of claim 5 wherein the user interface is operable to adjust size and orientation of the displayed image match the wall.

7. The home control system of claim 1 further comprising a camera operatively connected to the control apparatus for generating the image of the wall stored in the memory.

8. The home control system of claim 1 wherein the control apparatus comprises an input device connectable to an external device for transferring the image to the memory.

9. The home control system of claim 1 wherein the control apparatus operates using a screen saver mode to selectively display the image of the wall on the display screen to camouflage the user interface.

10. The home control system of claim 1 comprising an ambient light sensor and backlighting of the display screen is adjusted responsive to ambient light levels.

11. The home control system of claim 1 wherein the memory stores a color palette and the color palette is used to display a background color for a home screen.

12. A security system with a camouflaged connected controller, comprising:
a programmed control apparatus for controlling a security system that secures a home;
a user interface mountable to a wall in the home and operatively connected to the control apparatus, the user interface comprising a touch screen for receiving user input commands for operating the security system and displaying images relating to operation of the security system; and
a memory storing an image of the wall proximate the user interface,
the control apparatus being programmed to selectively displaying the image of the wall on the touch screen to camouflage the user interface.

13. The security system of claim 12 wherein the user interface is a peripheral device to the control apparatus and the memory is in the peripheral device.

14. The security system of claim 12 wherein the memory is in the control apparatus.

15. The security system of claim 12 wherein the user interface communicates with the control apparatus using a wireless interface.

16. The security system of claim 12 wherein the user interface is operable to adjust size and orientation of the displayed image to match the wall.

17. The security system of claim 12 further comprising a camera operatively connected to the control apparatus for generating the image of the wall stored in the memory.

18. The security system of claim 12 wherein the control apparatus comprises an input device connectable to an external device for transferring the image to the memory.

19. The security system of claim 12 wherein the control apparatus operates using a screen saver mode to selectively display the image of the wall on the touch screen to camouflage the user interface.

20. The security system of claim 12 comprising an ambient light sensor and backlighting of the touch screen is adjusted responsive to ambient light levels.

21. The security system of claim 12 wherein the memory stores a color palette and the color palette is used to display a background color for a home screen.
